(19) United States
(12) Patent Application Publication
(10) Pub. No.: US 2012/0331211 A1
(43) Pub. Date: Dec. 27, 2012

(54) SEMICONDUCTOR DEVICE AND PARAMETER SETTING METHOD THEREOF

(76) Inventor: Naoto WATANABE, Yokohama-shi (JP)

(21) Appl. No.: 13/529,230

(22) Filed: Jun. 21, 2012

(30) Foreign Application Priority Data
Jun. 22, 2011 (JP) 2011-138945

(51) Int. Cl. G06F 12/02

(52) U.S. Cl. 711/103; 711/E12.008

(57) ABSTRACT

According to one embodiment, a semiconductor device includes a nonvolatile memory configured to store setting data including a parameter and an address in which the parameter is to be set, and a register control circuit configured to read the setting data from the nonvolatile memory at the start time and set the parameter in the address. The semiconductor device includes a signal processing circuit operated according to the parameter stored in the register control circuit and a control signal supplied from a first interface after the setting data is set in the register control circuit.

### CROSS-REFERENCE TO RELATED APPLICATIONS

This application is based upon and claims the benefit of priority from prior Japanese Patent Application No. 2011-138945, filed Jun. 22, 2011, the entire contents of which are incorporated herein by reference.

### FIELD

Embodiments described herein relate generally to a semiconductor device and a parameter setting method thereof.

### BACKGROUND

In the conventional solid-state imaging device, an initial value that is previously determined to control a signal control circuit is stored in a register using flip-flops and ROMs. However, if such a register is used, it is necessary to reconstruct the register when a minor change is required to be made in the solid-state imaging device, when the result of initial evaluation obtained after the solid-state imaging device is formed is reflected, when a correction of the initial value of the register for a bug correction or the like of the solid-state imaging device is desired to be made or the like. Therefore, a problem that the number of processing steps of the solid-state imaging device is increased occurs. Further, if the register is formed of a rewritable nonvolatile memory, a problem that the area of the solid-state imaging device is increased occurs.

### BRIEF DESCRIPTION OF THE DRAWINGS

FIG. 1 is a block diagram schematically showing the basic configuration of a solid-state imaging device according to one embodiment.

FIG. 2 is block diagram schematically showing the test operations before shipment of the solid-state imaging device according to this embodiment.

FIG. 3 is block diagram schematically showing the operations at the start time of the solid-state imaging device according to this embodiment.

FIG. 4 is a block diagram schematically showing a basic parameter setting method of a solid-state imaging device according to a modification 1 of this embodiment.

FIG. 5 is a flowchart for schematically illustrating the basic parameter setting method of the solid-state imaging device according to the modification 1 of this embodiment.

FIG. 6 is a block diagram schematically showing the basic configuration of a solid-state imaging device according to a modification 2 of this embodiment.

FIG. 7 is a block diagram schematically showing the basic configuration of a solid-state imaging device according to a modification 3 of this embodiment.

FIG. 8 is a block diagram schematically showing the basic configuration of a solid-state imaging device according to a modification 4 of this embodiment.

### DETAILED DESCRIPTION

In general, according to one embodiment, a semiconductor device includes a nonvolatile memory configured to store setting data including a parameter and an address in which the parameter is to be set, and a register control circuit configured to read the setting data from the nonvolatile memory at the start time and set the parameter in the address. The semiconductor device includes a signal processing circuit operated according to the parameter stored in the register control circuit and a control signal supplied from a first interface after the setting data is set in the register control circuit.

The present embodiment is explained in detail below with reference to the drawings. In the explanation, common reference symbols are attached to common portions throughout the drawings.

### Embodiment

### <Outline of Configuration>

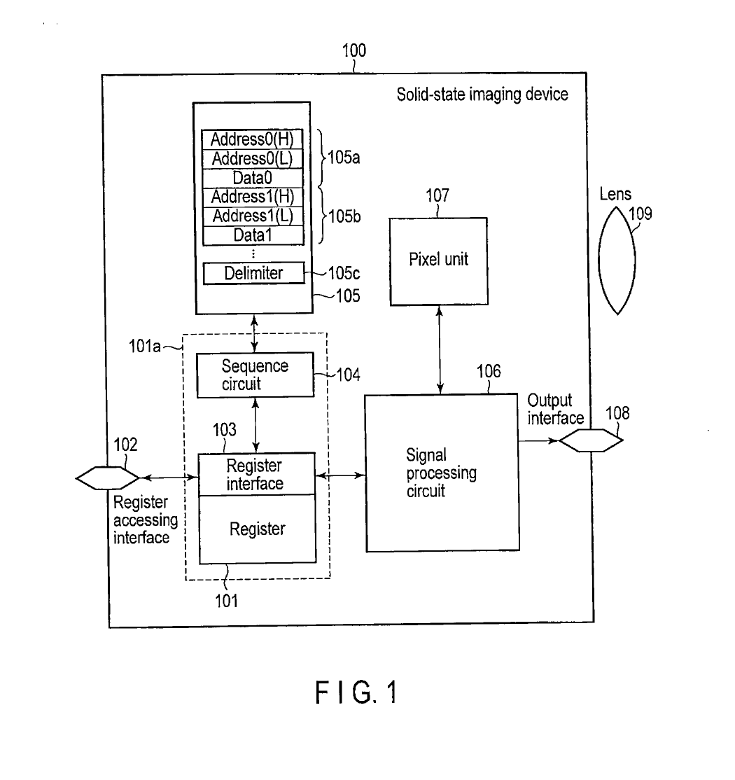

In FIG. 1, the basic configuration of a semiconductor device according to one embodiment is schematically explained. FIG. 1 is a block diagram schematically showing the basic configuration of the semiconductor device according to one embodiment. In the following embodiments and modifications, a concrete example in which a solid-state imaging device is used as one example of the semiconductor device is explained.

As shown in FIG. 1, a solid-state imaging device (also referred to as a chip) 100 includes a register 101, register accessing interface 102, register interface 103, sequence circuit 104, eFuse 105, signal processing circuit 106, a pixel unit 107 that receives light via a lens 109 and an output interface 108. The above units are explained in detail below.

The register 101 has a rewritable register space and a register initial value (that is also simply referred to as an initial value) such as a parameter or the like used for changing the gain of brightness, for example, is set therein. For example, the register initial value is set as an initial value of a flip-flop. A plurality of addresses and a plurality of functions of the register 101 respectively correspond to one another and the operation of the signal processing circuit 106 is controlled based on data (also referred to as a parameter or register value) set in each address. Further, data (initial value) of a corresponding address is overwritten (updated) based on data supplied via the sequence circuit 104 and register interface 103 and stored in the eFuse 105. A method for overwriting the initial value is explained in detail later. For example, the bit width of the address of the register 101 is 16 bits and the bit width of data is 8 bits.

The register accessing interface 102 supplies register setting data (that is also simply referred to as setting data) including data supplied from a tester (not shown), for example, and the address of the register 101 in which the data is set to the register interface 103. Further, for example, a control signal such as a clock signal or the like used to control the signal processing circuit 106 is supplied to the register interface 103.

The register interface 103 supplies register setting data input from the register accessing interface 102 to the sequence circuit 104. Further, the register interface 103 supplies data supplied from the sequence circuit 104 to the register 101. The register 101 is referred to from the signal processing circuit 106. The bit width of data from the register interface 103 to the sequence circuit 104 is 8 bits, for example.

The sequence circuit 104 writes register setting data supplied from the register interface 103 in the eFuse 105 and supplies data read from the eFuse 105 to the register interface 103.

The register 101, register interface 103 and sequence circuit 104 may be collectively dealt with as a register control circuit 101a (refer to a portion indicated by broken lines).

In the eFuse 105, for example, MODEL ID used for identifying a solid-state imaging device, a fault address of a Redundancy SRAM/DRAM (not shown), defect information of the pixel unit 107, the photodiode saturation characteristic of each solid-state imaging device and data (updated parameter or simply referred to as a parameter) related to a setting in a portion other than a portion that is assumed at the initial designing time can be set (stored). That is, correction values for the initial values of the respective settings set in the register 101 can be stored in the eFuse 105. Thus, the eFuse 105 can store parameters for correcting or changing all of the parameters (or desired parameters) stored in the respective addresses of the register 101 and addresses (setting data) of the register 101 in which the parameters are set. A method of setting each setting data in the eFuse 105 is explained in detail later. The eFuse 105 is not necessarily an eFuse and may be formed of another nonvolatile memory.

The signal processing circuit 106 includes an ADC (Analog-to-Digital converter) (not shown) that subjects a video signal (image signal) read from the pixel unit 107 to A/D (Analog-to-Digital) conversion to obtain a digital signal, a canceller (not shown) that cancels noise and pixel defects and the like. For example, the signal processing circuit 106 acquires the digital signal based on various parameters set in the register 101. That is, the signal processing circuit 106 is controlled according to various parameters set in the register 101. Further, the signal processing circuit 106 controls the solid-state imaging device 100 based on a control signal supplied from the exterior of the solid-state imaging device 100 via the register accessing interface 102. As a concrete example, the signal processing circuit 106 controls the timing of the solid-state imaging device 100 based on a clock signal supplied thereto.

The pixel unit 107 is a CMOS sensor, for example, and includes a plurality of pixel elements (also referred to as pixels) arranged in a matrix form. That is, in the pixel unit 107, the shutter operation and read operation (reset operation and video signal read operation) are performed for the plurality of pixels arranged based on a signal supplied from the signal processing circuit 106.

The output interface 108 outputs a digital signal acquired by the signal processing circuit 106 from the pixel unit 107, for example.

The lens 109 receives light from the exterior and supplies the received light to the pixel unit 107 via a resolution filter (not shown).

<Test Operation before Shipment>

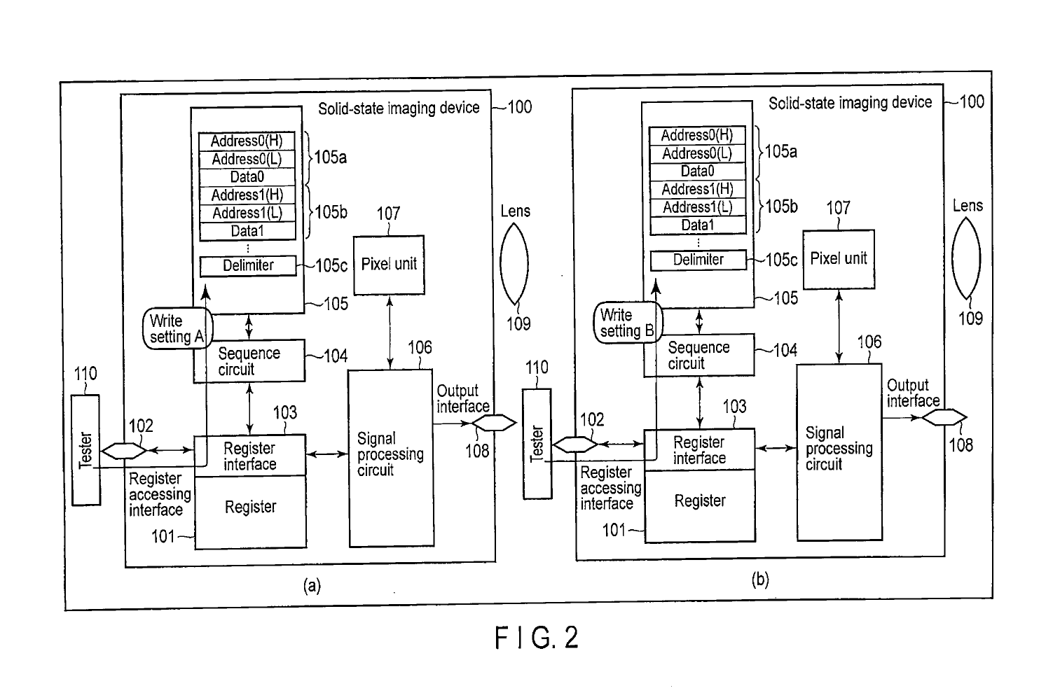

Next, the test operation before shipment of the solid-state imaging device 100 according to this embodiment is explained with reference to FIGS. 2(a) and 2(b). FIGS. 2(a) and 2(b) are block diagrams schematically showing the test operations before shipment of the solid-state imaging device 100 according to this embodiment.

For example, the test operation before shipment is an operation performed after formation of the solid-state imaging device 100 is ended. In this example, a case wherein register setting data (including data and an address of the register 101 in which data is set) is written in the eFuse 105 is explained. This operation is performed, for example, when a minor change is required to be made with a single integrated circuit used as a base, when the result of initial evaluation of the solid-state imaging device is reflected on the initial value of the register, when an initial value of the register is corrected for a bug correction and the like of the solid-state imaging device or the like.

As shown in FIG. 2(a), a tester 110 is connected to the register accessing interface 102. Then, the tester 110 writes desired register setting data (for example, setting A) in the eFuse 105 via the register accessing interface 102, register interface 103 and sequence circuit 104. Setting A includes various parameters (register values) for changing initial values and the like stored in the register 101, for example, and addresses of the register 101 in which the parameters are stored. In this example, for example, it is assumed that the bit width at the time of accessing the eFuse 105 is 8 bits, the address of the register 101 is 16 bits and the bit width of data is 8 bits.

First, in order to change initial value data of a desired address (for example, Address 0) of the register 101 to correction data (for example, Data 0), the upper 8 bits (Address 0(H)), lower 8 bits (Address 0(L)) and data 8 bits (Data 0) of the address are sequentially supplied from the tester 110 to the sequence circuit 104. Then, the sequence circuit 104 sequentially writes the upper 8 bits (Address 0(H)), lower 8 bits (Address 0(L)) and data 8 bits (Data 0) of the address in an eFuse 105a. Next, in order to change initial value data of a desired address (for example, Address 1) of the register 101 to correction data (for example, Data 1), the upper 8 bits (Address 1(H)), lower 8 bits (Address 1(L)) and data 8 bits (Data 1) of the address are sequentially supplied from the tester 110 to the sequence circuit 104. Then, the sequence circuit 104 sequentially writes the upper 8 bits (Address 1(H)), lower 8 bits (Address 1(L)) and data 8 bits (Data 1) of the address in an eFuse 105b. Likewise, when a parameter (data) in which the initial value stored in the register 101 is required to be changed is supplied from the tester 110, the sequence circuit 104 writes the parameter in the eFuse 105. At the end time of writing of setting A, a code indicating the end of writing of register setting data and a previously defined delimiter (Delimiter) are supplied from the tester 110 and the sequence circuit 104 writes the delimiter in an eFuse 105c.

Like the case of FIG. 2(a), in FIG. 2(b), a case wherein register setting data (setting B different from setting A) is written in the eFuse 105 is shown. In this case, for simplicity, like the case of FIG. 2(a), correction data (Data 0) of the address (Address 0) of the register 101 is written in the eFuse 105a, correction data (Data 1) of the address (Address 1) of the register 101 is written in the eFuse 105b and the delimiter (Delimiter) is written in the eFuse 105c. However, each address or each data written in the eFuse 105 of FIG. 2(b) is different from each address or each data written in the eFuse 105 of FIG. 2(a).

### <Operation at Practical Use Time>

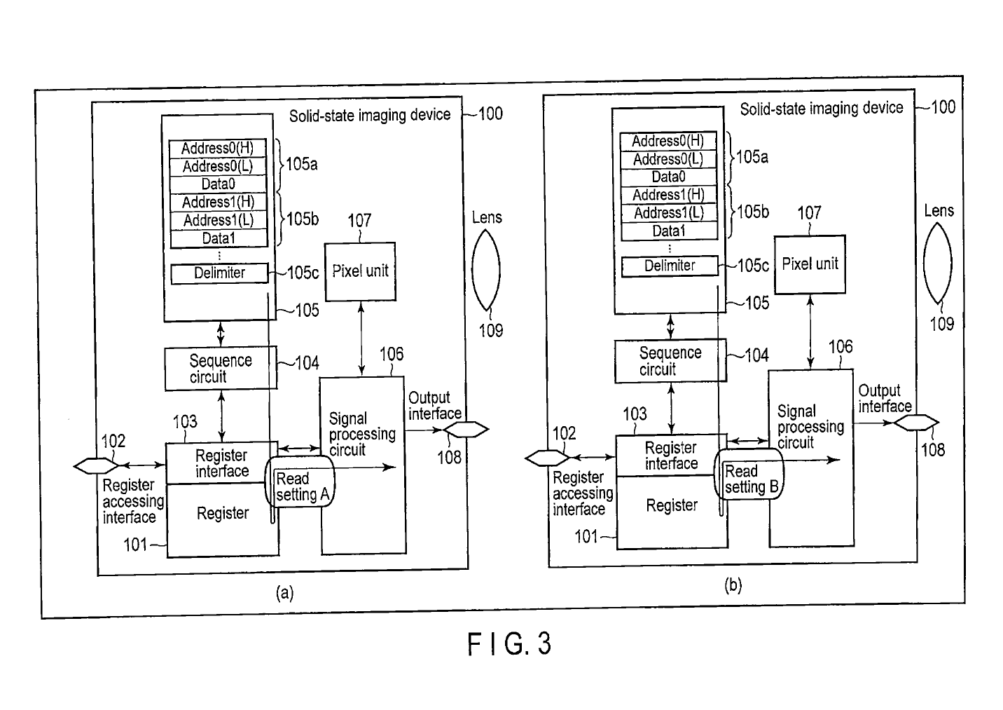

Next, the operation (that is also referred to as the operation at the practical use time) at the start time of the solid-state imaging device 100 according to this embodiment is explained with reference to FIGS. 3(a) and 3(b). FIGS. 3(a) and 3(b) are block diagrams schematically showing the operations at the start time of the solid-state imaging device 100 according to this embodiment.

In the solid-state imaging device 100 of this example, the register 101 is initialized by use of an initial value of a flip-flop immediately after starting. Then, as shown in FIG. 3(a), the sequence circuit 104 sequentially reads an address, data and delimiter that are setting A stored in the eFuse 105 and sequentially supplies the thus read address and data to the register interface 103. The register interface 103 writes data (Data 0) related to an address (for example, Address 0) in the address (Address 0) of the register 101 based on the sequentially supplied address and data. Likewise, the register interface 103 writes data related to an address in the supplied address of the register 101 until the delimiter (Delimiter) is detected. When detecting the delimiter (Delimiter), the register interface 103 terminates the write operation with respect to the register 101 and transfers the operation thereof to the normal boot sequence of the signal processing circuit 106. At this time, the signal processing circuit 106 refers to a parameter of the register 101 corrected based on setting A (various parameters). Then, the signal processing circuit 106 is operated according to the parameter corrected based on setting A.

Further, when an address and data that are setting B are stored in the eFuse 105 as shown in FIG. 3(b), the register 101 is corrected based on setting B as in the method explained with reference to FIG. 3(a). Then, the signal processing circuit 106 is operated according to the parameter of the register 101 corrected based on setting B.

As explained in FIGS. 3(a) and 3(b), the signal processing circuit 106 is operated according to register setting data (setting) written in the eFuse 105 from the tester 110.

### <Operation and Effect of Present Embodiment>

According to the embodiment described above, the solid-state imaging device (semiconductor device) 100 includes the nonvolatile memory (eFuse) 105 that stores setting data including a parameter (updated parameter) and an address in which the parameter is set and the register control circuit 101a that reads setting data from the eFuse 105 at the start time and in which a parameter is set (written) in the address. Further, the solid-state imaging device 100 includes the signal processing circuit 106 that is operated according to the control signal supplied from the register accessing interface 102 and the parameter stored in the register control circuit 101a after setting data is set in the register control circuit 101a and the pixel unit 107 that is connected to the signal processing circuit 106 and operated by means of the signal processing circuit 106. The parameter setting method of the solid-state imaging device 100 includes preparing an updated parameter used for updating a parameter in the register 101 and an address in which an updated parameter is set, and writing the updated parameter and address in the eFuse 105. The register 101 updates a parameter (initial value) corresponding to an address by use of an updated parameter based on the updated parameter and address supplied from the eFuse 105 and the signal processing circuit 106 performs a boot sequence after the parameter is updated. The parameter setting method of the solid-state imaging device (semiconductor device) 100 includes preparing a parameter stored in the register control circuit 101a and used for controlling the operation of the signal processing circuit 106 and an address in which the parameter is set, and writing the parameter and the address in which the parameter is set in the eFuse 105 via the register control circuit 101a.

Thus, the solid-state imaging device of this embodiment can hold the initial value correction information (including a parameter and an address in which the parameter is set) of the register in the nonvolatile memory (eFuse). Therefore, a parameter stored in the register can be corrected without reconfiguring the register if the register is configured by flip-flops. Further, the solid-state imaging device of this embodiment reflects the initial value correction information of the register held in the nonvolatile memory (eFuse) on the register before the boot sequence. That is, calibration information or setting change information is written in the nonvolatile memory (eFuse) according to each version or each individual at the testing time before shipment of the solid-state imaging device and the solid-state imaging device can be started with an optimum setting by writing the information in the register at the start time of the solid-state imaging device.

Further, in the solid-state imaging device (integrated circuit) having a nonvolatile memory (eFuse) of a small capacity such as an effuse mounted thereon, a portion of the nonvolatile memory is used for changing the initial value setting of the register. Therefore, the setting of the register can be easily changed while an increase in the development cost of the solid-state imaging device and an increase in the area of the register are suppressed.

Thus, for example, it becomes easy by using a single solid-state imaging device as a base to make a minor change, reflect the result of initial evaluation of the solid-state imaging device on the register, correct the initial value of the register for bug correction of the solid-state imaging device and the like. As a result, this can contribute to a further reduction in the semiconductor mask refinement (register reformation).

In the embodiment described above, a case wherein register setting data different from setting A or setting B is stored in the eFuse 105 by means of the chip (solid-state imaging device) is explained. For example, the same register setting data is written in all of the solid-state imaging devices in the case of bug correction data or the like. However, there is a case where it is desired to separate a solid-state imaging device of “image quality preference setting (for example, setting A)” and a solid-state imaging device of “frame rate preference setting (for example, setting B)” from each other. In such a case, solid-state imaging devices of the respective settings can be acquired without additionally making settings at the practical use time by writing the respective setting values in the solid-state imaging devices for each wafer or for each lot, for example. Specifically, the same setting (setting A or setting B) is set in the solid-state imaging device belonging to the same lot or the same silicon.

### Modification 1

Next the modification 1 of the above embodiment is explained.

The modification 1 is a method for making various tests for a solid-state imaging device 100 by means of a tester at the test operation time before shipment of the solid-state imaging device and setting a correction parameter in the eFuse 105 together with an address of the register 101 in which the correction parameter is stored when it is required to correct the initial value (parameter) of the register due to the test.

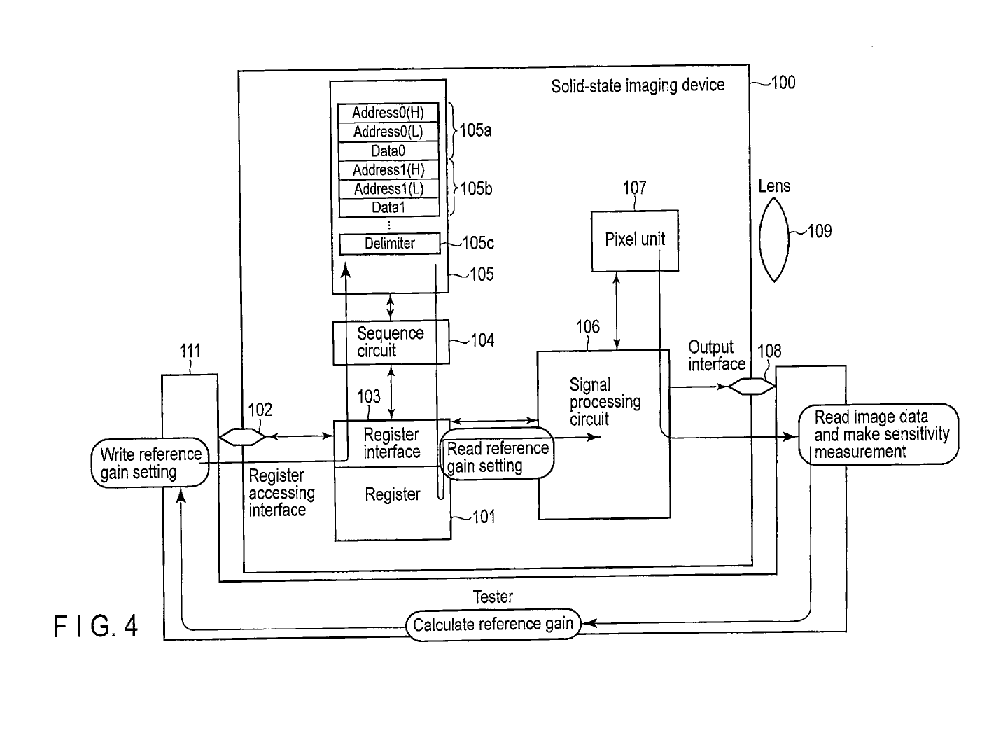

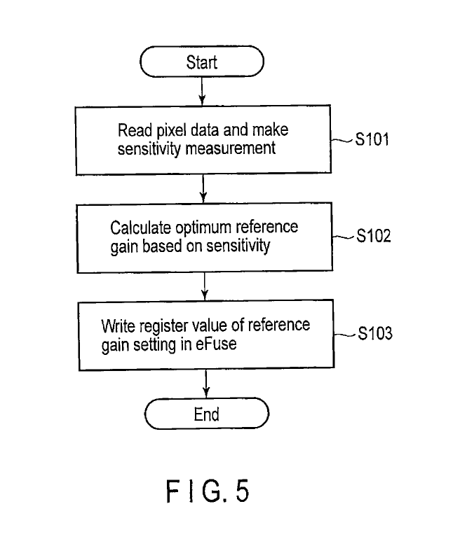

A basic parameter setting method of a solid-state imaging device according to the modification 1 of this embodiment is schematically explained with reference to FIGS. 4 and 5. FIG. 4 is a block diagram schematically showing the basic parameter setting method of the solid-state imaging device according to the modification 1 of this embodiment. FIG. 5 is a flowchart for schematically illustrating the basic parameter setting method of the solid-state imaging device according to the modification 1 of this embodiment. The basic configuration and basic operation of the solid-state imaging device according to the modification 1 are the same as those of the solid-state imaging device according to the embodiment described above. Therefore, in the explanation for the modification 1, the explanation for the same portions as those of the above embodiment is omitted.

In the modification 1, for example, a case is considered in which the sensitivity of a pixel unit is measured in each solid-state imaging device (chip) at the test operation time before shipment and the reference gain is automatically adjusted for each solid-state imaging device according to the measurement result. Since the sensitivity characteristic of the pixel unit varies depending on variations in manufacturing, an optimum reference gain setting may be made for each solid-state imaging device.

<Test Operation before Shipment>

In this example, a case where the sensitivity of the pixel unit is measured in each solid-state imaging device after formation of the solid-state imaging device is terminated and reference gain setting data is written in the eFuse 105 for each solid-state imaging device according to the measurement result.

As shown in FIG. 4, a tester 111 is connected to the register accessing interface and is also connected to an output interface.

As shown in FIG. 5, the following operation is performed.

### Step S101

First, the tester 111 reads pixel data of the pixel unit 107 to make the sensitivity measurement. As one example of the sensitivity measurement operation, for example, an image (reference image) used as a reference is photographed in the pixel unit 107 via the lens 109 and an image signal is acquired by means of the tester 111. Then, the tester 111 causes the signal processing circuit 106 to subject the image signal read from the pixel unit 107 to A/D conversion and acquire a digital signal (pixel data). The pixel data is output to the tester 111 via the output interface 108. The tester 111 measures the sensitivity of the pixel unit 107 based on output pixel data.

### Step S102

Next, the tester 111 calculates an optimum reference gain based on the sensitivity derived from the pixel data. The reference gain is a gain supplied to the signal processing circuit 106 to cause the output of the signal processing circuit 106 corresponding to a preset reference light amount to become equal to preset reference sensitivity.

### Step S103

Subsequently, the tester 111 supplies a setting (for example, that is referred to as a reference gain setting) including a parameter (register value) corresponding to the reference gain and an address of the register 101 in which the parameter of the reference gain is stored to the sequence circuit 104 via the register accessing interface 102 and register interface 103 and the sequence circuit 104 writes the setting in the effuse 105.

### <Operation at Practical Use Time>

Like the solid-state imaging device according to the embodiment described above, the register 101 in the solid-state imaging device 100 of this example is initialized according to an initial value of the flip-flop or the like immediately after starting. Then, as shown in FIG. 4, the sequence circuit 104 reads the reference gain setting stored in the effuse 105 and supplies the read reference gain setting to the register interface 103. Subsequently, the register interface 103 writes a parameter related to the reference gain in an address related to the reference gain of the register 101 based on the reference gain setting supplied thereto. The register interface 103 writes data supplied from the effuse 105 according to an address related to data until a delimiter (Delimiter) is detected. When detecting the delimiter (Delimiter), the register interface 103 terminates the write operation with respect to the register 101 and transfers the operation thereof to the normal boot sequence of the signal processing circuit 106. That is, the signal processing circuit 106 is operated according to a reference gain calculated by means of the tester 111.

### <Operation and Effect of Modification 1>

According to the modification 1 described above, the operation of preparing a parameter stored in the register control circuit 101a and used for controlling the operation of the signal processing circuit 106 and an address in which the parameter is set includes checking the pixel unit 107 via the signal processing circuit 106 and determining a parameter based on the result of checking.

Since the configuration of the solid-state imaging device according to the modification 1 is substantially the same as that of the solid-state imaging device explained in the above embodiment, substantially the same effect as the effect explained in the above embodiment can be attained. However, the test operation before shipment of the solid-state imaging device according to the modification 1 is performed by checking the solid-state imaging device by means of the tester (for example, checking the pixel unit), deriving an adequate parameter based on the result of checking and storing an adequate parameter and an address in which the parameter is set in the effuse 105. The checking operation is performed for each chip (solid-state imaging device), for example. As a result, variations different for the respective solid-state imaging devices caused by variations in manufacturing can be automatically adjusted and the solid-state imaging device can be started with an optimum setting without performing a process such as a register reformation process.

As one example of the test operation, the tester 111 derives a reference gain based on pixel data from the pixel unit 107 and supplies a reference gain setting to the effuse 105. However, the operation is not limited to the above case and any operation can be applied in the modification 1 if the operation is a test related to the solid-state imaging device.

### Modification 2

Next, the modification 2 of the embodiment is explained.

The modification 2 is different from the above embodiment in that the solid-state imaging device further includes a testing interface connected to a sequence circuit and used only at the test operation time before shipment of the solid-state imaging device.

### <Outline of Solid-State Imaging Device>

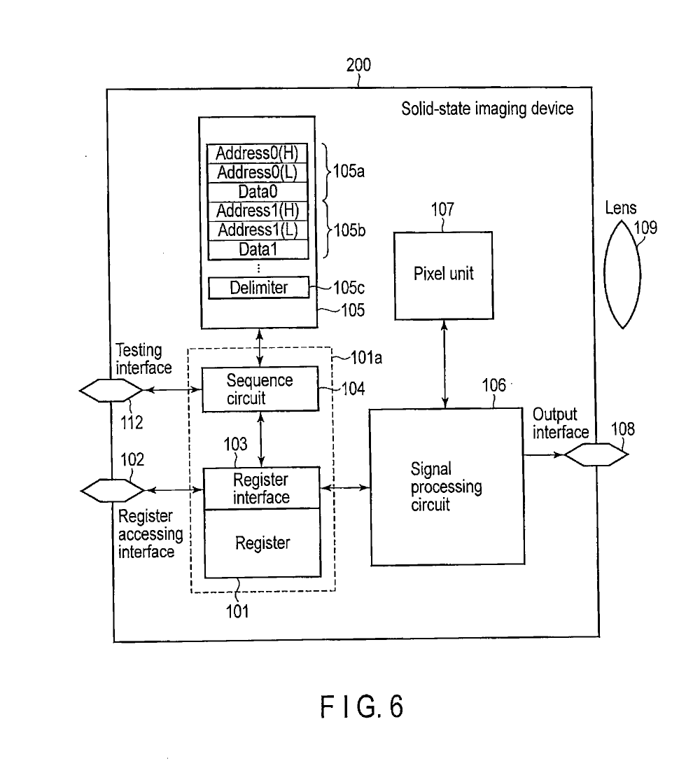

The basic configuration and a parameter setting method of a solid-state imaging device according to the modification 2 of this embodiment are schematically explained with reference to FIG. 6. FIG. 6 is a block diagram schematically showing the basic configuration of the solid-state imaging device according to the modification 2 of this embodiment. The basic configuration and basic operation of the solid-state imaging device according to the modification 2 are the same as those of the solid-state imaging device according to the embodiment described above. Therefore, in the explanation for the modification 2, the explanation for the same portions as those of the above embodiment is omitted.

As shown in FIG. 6, for example, a testing interface 112 supplies register setting data supplied from a tester (not shown) to a sequence circuit 104. The testing interface 112 uses 8 bits among 13 bits of an output interface 108, for example, and is made valid only at the test operation time before shipment of the solid-state imaging device. For example, the testing interface 112 functions as a terminal for a different application of the output interface 108 of the signal processing circuit 106 after the test operation before shipment. The testing interface 112 may be configured by means of a portion of an interface different from the output interface 108. At this time, for example, the testing interface 112 can be used as a terminal of an output interface of the signal processing circuit 106 connected in parallel with the output interface 108 after the test operation before shipment.

<Test Operation before Shipment, Operation at Practical Use Time>

Next, a method for writing an address and data in the eFuse 105 at the test operation time before shipment of a solid-state imaging device 200 according to the modification 2 is explained. The basic write method is substantially the same as that explained in the above embodiment and the explanation thereof is omitted.

A tester (not shown) is connected to the testing interface 112. The tester supplies desired register setting data (various parameters and addresses of the register 101 in which the parameters are stored) to the sequence circuit 104 via the testing interface 112 and the sequence circuit 104 writes the register setting data in the eFuse 105. Since the operation of the solid-state imaging device 200 according to the modification 2 at the start time is the same as that explained in the above embodiment, the explanation thereof is omitted.

### <Operation and Effect of Modification 2>

According to the modification 2 described above, the solid-state imaging device 200 further includes the testing interface (third interface) 112 that is connected to the sequence circuit 104 to supply setting data to the sequence circuit 104 in addition to the configuration of the solid-state imaging device 100. Further, the testing interface 112 is also used as a terminal for outputting an output signal of the signal processing circuit 106.

The operation of writing setting data in the eFuse 105 via the testing interface 112 and sequence circuit 104 can be performed at higher speed in comparison with the operation of writing setting data in the eFuse 105 via the register accessing interface 102, register interface 103 and sequence circuit 104 since the number of circuits relayed is less. For example, the testing interface 112 uses a portion of the output interface 108 that outputs an output signal of the signal processing circuit 106. Therefore, according to the modification 2, setting data can be written in the eFuse 105 at higher speed while the same effect as that of the above embodiment is attained and an increase in the manufacturing cost of the solid-state imaging device and an increase in the area thereof are suppressed.

### Modification 3

Next, the modification 3 is different from the above embodiment in that the solid-state imaging device includes a register accessing interface control circuit that changes the characteristic of a register accessing interface according to a register value in the register.

### <Outline of Solid-State Imaging Device>

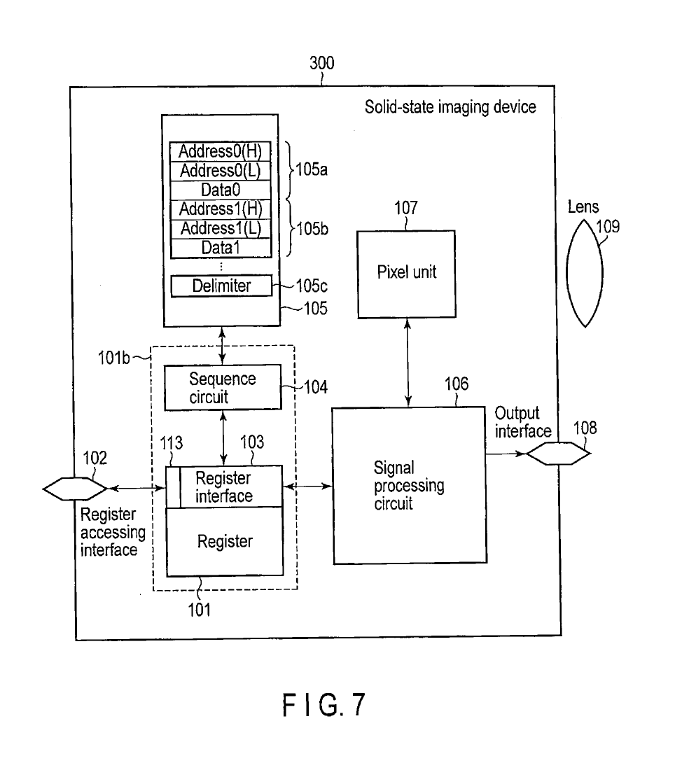

The basic configuration of a solid-state imaging device according to the modification 3 of the above embodiment is schematically explained with reference to FIG. 7. FIG. 7 is a block diagram schematically showing the basic configuration of the solid-state imaging device according to the modification 3 of this embodiment. The basic configuration and basic operation of the solid-state imaging device according to the modification 3 are the same as those of the solid-state imaging device according to the embodiment described above. Therefore, in the explanation for the modification 3, the explanation for the same portions as those of the above embodiment is omitted.

As shown in FIG. 7, for example, a register accessing interface control circuit 113 includes a sequence circuit (not shown) and control unit (not shown) and is connected to the register 101, register accessing interface 102 and register interface 103. The control unit can freely change the characteristic of the register accessing interface 102 based on the parameter by reading a parameter (register value) of the register 101 via the sequence circuit at the start time of the solid-state imaging device. As one example of the parameter, a parameter used for changing the clock frequency of the register accessing interface 102 may be provided, for example. An address in which the parameter of the register accessing interface control circuit 113 is stored is prepared in the register 101. The register 101, register accessing interface control circuit 113, register interface 103 and sequence circuit 104 may be collectively dealt with as a register control circuit 101a (refer to a portion indicated by broken lines).

Since the test operation before shipment of the solid-state imaging device 300 according to the modification 3 and the basic operation thereof at the practical use time are the same as those explained in the embodiment described above, the detailed explanation thereof is omitted.

### <Operation and Effect of Modification 3>

According to the modification 3 described above, the solid-state imaging device 300 further includes the register accessing interface control circuit 113 that is connected to the register accessing interface (first interface) 102, register•interface (second interface) 103 and register 101 to control the register accessing interface 102 based on the parameter stored in the register 101 in addition to the configuration of the solid-state imaging device 100.

According to the above configuration, the setting of the register accessing interface control circuit 113 can be changed according to the parameter in the register 101. Further, the characteristic of the register accessing interface 102 that is difficult to be directly changed can be changed by means of the register accessing interface control circuit 113. That is, if a parameter used for changing the characteristic of the register accessing interface 102 is stored in the eFuse 105, the characteristic of the register accessing interface 102 can be freely changed. As a result, the setting of the register accessing interface control circuit itself can be changed while the same effect as that of the above embodiment is maintained.

### Modification 4

Next, the modification 4 of the above embodiment is explained.

The modification 4 is different from the above embodiment in that the solid-state imaging device includes a testing interface (that is the same as that of the modification 2) connected to a sequence circuit and used only at the test operation time before shipment and a register accessing interface control circuit (that is the same as that of the modification 3) that changes the characteristic of a register accessing interface according to a register value in the register.

### <Outline of Solid-State Imaging Device>

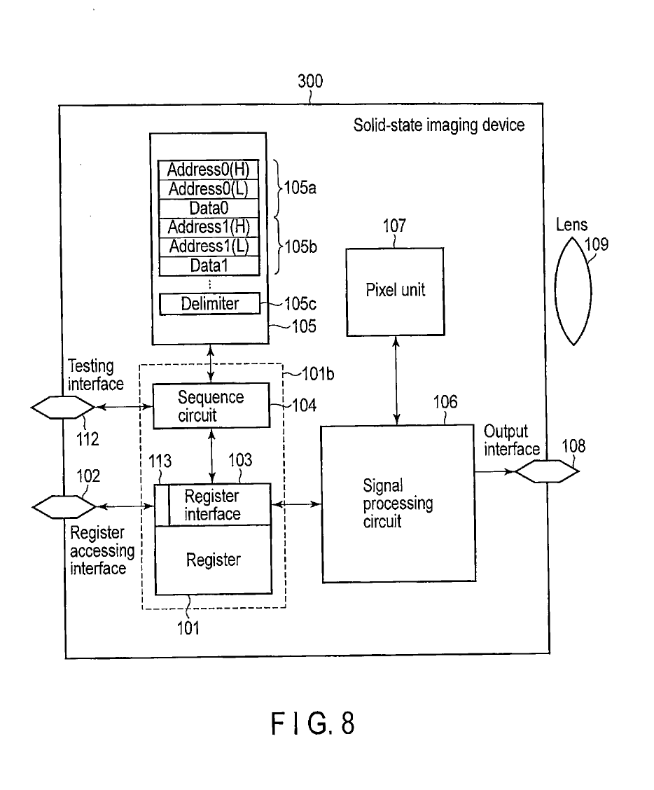

The basic configuration of a solid-state imaging device according to the modification 4 of the above embodiment is schematically explained with reference to FIG. 8. FIG. 8 is a block diagram schematically showing the basic configuration of the solid-state imaging device according to the modification 4 of this embodiment. The basic configuration and basic operation of the solid-state imaging device according to the modification 4 are the same as those of the solid-state imaging devices according to the embodiment described above, modification 2 and modification 3. Therefore, the detailed explanation for the modification 4 is omitted.

### <Operation and Effect of Modification 4>

According to the modification 4 described above, like the configuration of the modification 2 and the configuration of the modification 3, the solid-state imaging device 400 further includes a testing interface (third interface) 112 that is connected to the sequence circuit 104 and supplies setting data to the sequence circuit 104 in addition to the configuration of the solid-state imaging device 100. Further, the solid-state imaging device 400 includes a register accessing interface control circuit 113 that is connected to the register accessing interface (first interface) 102, register•interface (second interface) 103 and register 101 to control the register accessing interface 102 based on the parameter stored in the register 101. Therefore, when resister setting data is written in the eFuse 105, the resister setting data is not influenced by the characteristic of the register accessing interface 102 since the resister setting data is not supplied via the register accessing interface 102. As a result, a parameter or the like used for changing the characteristic of the register accessing interface 102 can be easily stored in the eFuse 105.

Like the modification 3, when the parameter used for changing the characteristic of the register accessing interface 102 is stored in the eFuse 105, the characteristic of the register accessing interface 102 can be freely changed. Thus, the parameter used for changing the characteristic of the register accessing interface 102 can be more easily stored in the eFuse 105 while the same effect as that of the above embodiment, modification 2 and modification 3 is maintained.

In the above embodiment and modifications, an initial value is previously set in the register 101 at the manufacturing stage of the solid-state imaging device. Specifically, concrete parameters with various functions are previously set in the flip-flops of the register 101. However, for example, any value may be stored in the flip-flop of the register 101 and, for example, “0”, “1” or given values (meaningless values) may be set in all of the flip-flops. Thus, a value previously set in the register 101 at the manufacturing stage of the solid-state imaging device is called an initial value, for example. If concrete parameters with various functions are not set in the register 101, concrete parameters with various functions can be stored in the eFuse 105.

Further, in the above embodiment and modifications, the solid-state imaging device is used as one example of the semiconductor device, but the device is not limited to this case and any device can be used if the device is an integrated circuit.

Further, in the above embodiment and modifications, a CMOS is used as one example of the pixel unit, but the device is not limited to the above case and a CCD may be used.

Additionally, in the above embodiment and modifications, the register is used, but this is not limited to the above case and any memory may be used if the memory is a rewritable memory.

Further, in the above embodiment and modifications, the bit width at the time of access to the eFuse 105 is set to 8 bits, but this is not limited to the above case. The address of the register 101 is set to 16 bits and the bit width of data is set to 8 bits, but this is not limited to the above case. The upper address of 8 bits, lower address of 8 bits and data of 8 bits are sequentially written in the eFuse 105, but the order is not limited to the above case. Further, the address is divided into two portions of upper and lower addresses, but data may be divided into plural portions or the number of divisions of the address can be adjusted according to the number of bits of the address and data or the bit width at the time of access to the eFuse 105.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device comprising:
a nonvolatile memory configured to store setting data including a parameter and an address in which the parameter is set,
a register control circuit that reads the setting data from the nonvolatile memory at start time and in which the parameter is set in the address, and
a signal processing circuit configured to be operated according to a control signal supplied from a first interface and a parameter stored in the register control circuit after the setting data is set in the register control circuit.

2. The device according to claim 1, wherein the register control circuit includes a sequence circuit configured to read the setting data from the nonvolatile memory, a register in which the parameter is set in the address, and a second interface configured to write the setting data in the register and read the parameter of the register.

3. The device according to claim 2, wherein the nonvolatile memory stores a delimiter that indicates an end of the setting data.

4. The device according to claim 3, wherein the sequence circuit sequentially reads the address and data until the delimiter is detected.

5. The device according to claim 3, wherein the second interface transfers the operation of the signal processing circuit to a normal boot sequence when detecting the delimiter.

6. The device according to claim 2, further comprising a third interface connected to the sequence circuit and configured to supply the setting data to the sequence circuit.

7. The device according to claim 6, wherein the third interface is also used as a terminal that outputs an output signal of the signal processing circuit.

8. The device according to claim 6, further comprising an interface control circuit connected to the first interface, second interface and register to control the first interface based on a parameter stored in the register.

9. The device according to claim 2, wherein the signal processing circuit performs a boot sequence after the parameter is set in the register.

10. The device according to claim 2, further comprising an interface control circuit connected to the first interface, second interface and register to control the first interface based on a parameter stored in the register.

11. The device according to claim 1, wherein the setting data is supplied to the nonvolatile memory via the first interface and register.

12. The device according to claim 1, wherein the nonvolatile memory is an eFuse.

13. A parameter setting method for a semiconductor device including a processor, a register that stores a parameter used for controlling the processor and a nonvolatile memory, comprising:
preparing an updated parameter and an address in which the updated parameter is set,
writing the updated parameter and address in the nonvolatile memory,
updating a parameter set in the address to the updated parameter based on the address and updated parameter supplied from the nonvolatile memory by means of the register, and
performing a boot sequence after the parameter is updated by means of a signal processing circuit.

14. The method according to claim 13, further comprising storing a delimiter indicating an end of the setting data in the nonvolatile memory after the writing the updated parameter and address in the nonvolatile memory is terminated.

15. The method according to claim 14, wherein the updating the parameter set in the address to the updated parameter is performed until the delimiter is detected.

16. The method according to claim 14, wherein the performing the boot sequence is attained by means of the signal processing circuit when the delimiter is detected by the register.

17. The method according to claim 13, wherein the preparing the updated parameter and address includes checking a pixel unit via the signal processing circuit, and determining the updated parameter based on the result of checking.
